(19) United States
(12) Patent Application Publication
(10) Pub. No.: US 2007/0215186 A1
(43) Pub. Date: Sep. 20, 2007

(54) Rack Protecting Body of Dish Washer, and Dish Washer Using the Same

(76) Inventor: Jeong Woo Kim, Woolsan-si (KR)

Correspondence Address: MCKENNA LONG & ALDRIDGE LLP, 1900 K STREET, NW, WASHINGTON, DC, 20006, US

(21) Appl. No.: 10/592,496

(22) PCT Filed: Nov. 10, 2005
(86) PCT No.: PCT/KR05/03812

§ 371 Date: Sep. 12, 2006

(30) Foreign Application Priority Data
Nov. 10, 2004 (KR) 10-2004-0091196

(51) Int. Cl. B08B 3/00

(52) U.S. Cl. 134/56 D

(57) ABSTRACT

A rack protecting body of a dishwasher (100) and a dishwasher (100) using the same are provided. The rack protecting body (200) includes a cushion (210) that absorbs shock applied to the dish rack (300) and a coupling portion that couples the cushion (210) with the dish rack (300). The dishwasher (100) uses the rack protecting body (200) to absorb shock from collisions between the door (111) and the dish rack (300).

### TECHNICAL FIELD

The present invention relates to a dishwasher, and more particularly, to a rack protecting body of a dishwasher and a dishwasher using the same.

### BACKGROUND ART

A dishwasher is an apparatus that sprays wash liquid onto dish racks to wash dishes placed on the dish racks. As a component for storing dishes, a dish rack is installed inside a tub of a dishwasher. Generally, a dishwasher door is opened and the dish rack is pulled out and loaded with dishes. After the dishes are loaded, the dish rack is pushed back into the dishwasher.

However, if the door is closed when the rack is incompletely inserted into the tub, the inner surface of the door collides with the dish rack. Such collisions between the door and the dish rack can cause a scratch or a deformation such as a dent on the inside of the door. Collisions can also cause scratching or deforming such as bending of the dish rack. Such scratching or deforming of the inside of the door or the dish rack can lead to rusting thereof, due to exposure to moisture.

### DISCLOSURE OF INVENTION

Technical Problem

An object of the present invention is to provide a rack protecting body capable of absorbing shock from a collision between a door and a rack of a dishwasher.

Another object of the present invention is to provide a dishwasher having a structure capable of absorbing shock from a collision between a door and a rack of the dishwasher.

Technical Solution

To achieve these objects and other advantages in accordance with the present invention, as embodied and broadly described herein, there is provided a rack protecting body for a dishwasher having a dish rack including: a cushion for absorbing shock applied to the dish rack; and a coupling portion for coupling the cushion with the dish rack.

In another aspect of the present invention, there is provided a rack protecting body of a dishwasher having a dish rack formed of a rack frame with a plurality of intersecting frame lines, the rack protecting body including: a cushion for absorbing shock applied to the dish rack; and a frame line receiving groove for receiving the frame line, wherein the frame line receiving groove includes a radial center that is offset from a radial center of the cushion by a predetermined distance.

In a further aspect of the present invention, there is provided a dishwasher including: a door; a tub opened and closed by the door; a dish rack disposed within the tub; and a rack protecting body for absorbing shock incurred by a collision between the door and the dish rack.

Advantageous Effects

The dishwasher rack protecting body and the dishwasher using the same according to the present invention has the rack protecting body installed on a dish rack so that the shock from a collision between the door of the dishwasher and the rack can be absorbed. Accordingly, scratches or deforming of the door or the dish rack caused by the shock can be effectively prevented. Thus, the formation of rust caused by scratches or deforming of the door or dish rack can be prevented.

Especially, when the door is closed without completely inserting the dish rack into the dishwasher tub, and the rack collides with the door liner, the above effects are that much more pronounced.

### BRIEF DESCRIPTION OF THE DRAWINGS

FIG. 1 is a schematic sectional view of a dishwasher according to the present invention.

FIG. 2 is perspective view showing a rack protecting body installed on a dish rack according to the first embodiment of the present invention.

FIG. 3 is a perspective view of a rack protecting body according to the first embodiment of the present invention.

FIG. 4 is a plan view of the rack protecting body according to the first embodiment of the present invention.

FIG. 5 is a perspective view of a rack protecting body according to the second embodiment of the present invention.

FIG. 6 is a perspective view of a rack protecting body according to the third embodiment of the present invention.

FIG. 7 is a plan view of the rack protecting body according to the third embodiment of the present invention.

FIG. 8 is a perspective view of a rack protecting body according to the fourth embodiment of the present invention.

FIG. 9 is a perspective view of a rack protecting body according to the fifth embodiment of the present invention.

FIG. 10 is plan view of the rack protecting body according to the fifth embodiment of the present invention.

### BEST MODE FOR CARRYING OUT THE INVENTION

Hereinafter, preferred embodiments of the present invention will be described in detail with reference to accompanying drawings. However, the embodiments are not limited to the scope of this invention, and can easily encompass added elements, variations, and deletions which fall within the scope of embodiments in retrogressive inventions or the present invention.

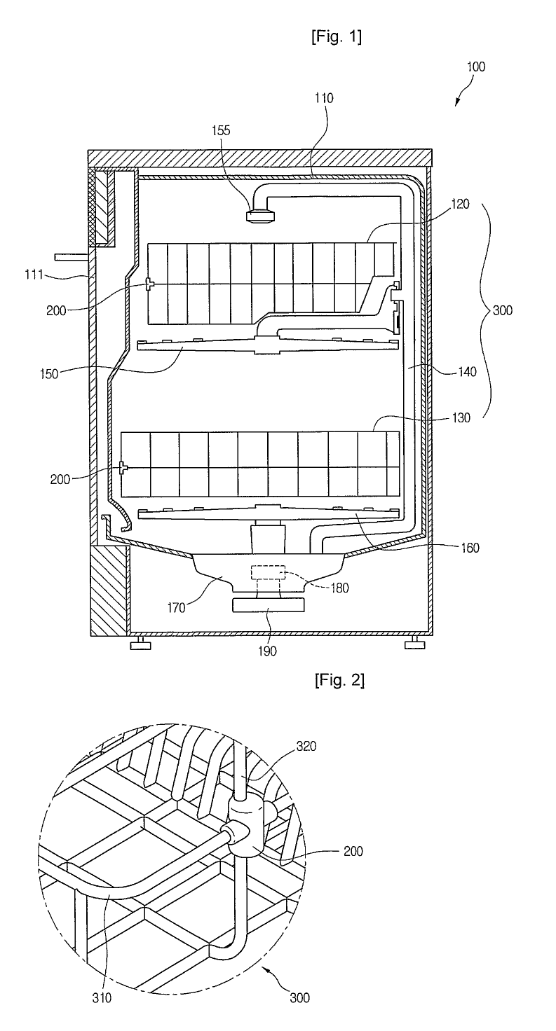

FIG. 1 is a schematic sectional view of a dishwasher according to the present invention.

Referring to FIG. 1, a dishwasher 100 according to the present invention includes a tub 110 forming the outer shape of the dishwasher 100 and a wash compartment within, a door 111 formed at the front of the tub 110 for opening and closing the wash compartment, and a sump 170 formed at a central bottom portion of the tub 110 for storing wash liquid.

Also included are a wash pump 180 connected to the sump 170 for pumping wash liquid stored in the sump 170 under high pressure, and motor 190 attached below the wash pump 180 for driving the wash pump 180.

Further included are a water guide 140 providing a passage for wash liquid pumped by the wash pump 180, a lower spray arm 160 provided at the top of the sump 170 and the bottom of the wash compartment for spraying wash liquid in an upward direction, an upper spray arm 150 attached at an upper portion of the water guide 140 to extend horizontally therefrom to be centrally disposed inside the wash compartment, and a top nozzle 155 formed at the ceiling of the tub 110 to spray wash liquid in a downward direction.

Additionally, the dishwasher 100 includes a dish rack 300 that can be an upper rack 120 installed above the upper spray arm 150 to wash dishes with the upper spray arm 150 or a lower rack 130 installed above the lower spray arm 160 to wash dishes with the lower spray arm 160, and a rack protecting bow 200 installed on a side of the dish rack 300 for protecting the dish rack 300 and the door.

The operation of the above dishwasher 100 according to the present invention will now be described.

First, a user opens the door 111 of the dishwasher 100, pulls the upper and/or lower racks 120 and 130 out, and places dishes in the dish racks 300. The door 111 is then closed, power is turned on, and the dishwasher 100 is activated.

When power to the dishwasher 100 is turned on and a wash cycle is instigated, wash liquid enters the sump 170. After the entering of wash liquid is completed, the wash motor 190 operates. An impeller (not shown), connected to a shaft of the motor 190 and disposed inside the wash pump 180, rotates to pump wash liquid to the lower spray arm 160 and the water guide 140.

The wash liquid pumped to the water guide 140 ultimately flows to the top nozzle 155 and the upper spray arm 150 to be sprayed therefrom into the wash compartment. The sprayed wash liquid washes dishes placed in the racks 300.

Here, the top nozzle 155 sprays wash liquid in a vertically downward direction and the upper spray arm 150 sprays wash liquid in a vertically upward direction to wash dishes placed in the upper rack 120.

The lower spray arm 160 sprays wash liquid in a vertically upward direction to wash dishes placed in the lower rack 130. Additionally, the lower spray arm 160 is made to spray wash liquid in a downward direction as well, to prevent the mesh filter installed on top of the sump 170 from being clogged by food residue. Also, spray holes may be formed at the bottom of the upper spray arm 150, to allow the upper spray arm 150 to spray wash liquid in both upward and downward directions, thereby simultaneously washing the tops of dishes placed in the lower rack 130.

When the wash cycle is completed, the dirty wash liquid collected in the sump 170 is filtered of impurities by means of a filter (not shown). A drain pump (not shown) dispels the filtered wash liquid to the outside of the dishwasher 100.

After the wash liquid is dispelled to the outside, fresh wash liquid enters the sump 170 through an inlet, whereupon the wash liquid is sprayed through the spray arms 150 and 160 in the same manner as in the wash cycle. The clean, sprayed wash liquid rinses the dishes in a rinse cycle. When the rinse cycle is completed, a drying cycle is implemented to complete the dishwashing process.

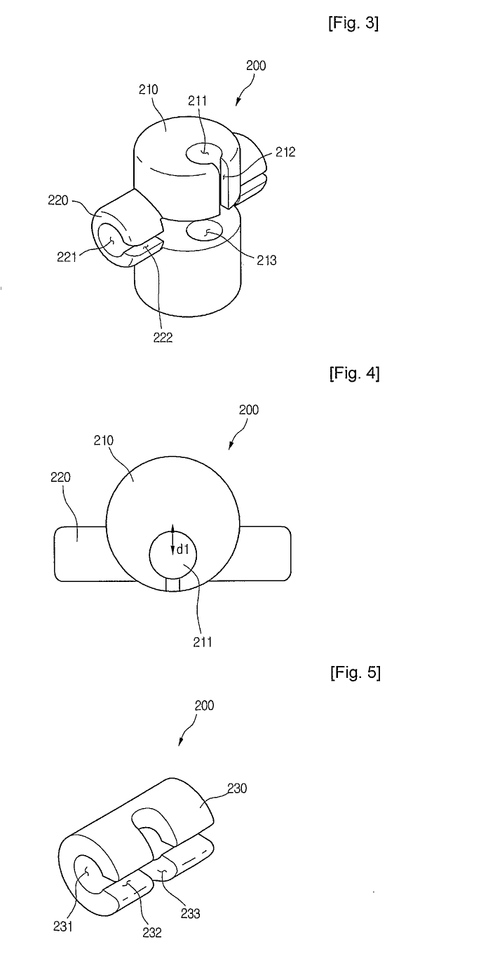

FIG. 2 is perspective view showing a rack protecting body installed on a dish rack according to the first embodiment of the present invention, and FIG. 3 is a perspective view of a rack protecting body according to the first embodiment of the present invention.

Referring to FIGS. 2 and 3, the rack protecting body 200 is coupled to the rack frame of the dish rack 300.

Specifically, the dish rack 300 includes an arcuate horizontal frame line 310 intersecting with a rounded vertical frame line 320. Accordingly, the rack 300 prevents dishes from falling by means of a supporting frame, and spaces of a predetermined size are defined between the intersecting frame lines for wash liquid to fall to the floor of the wash compartment through.

Here, the dish rack 300 is formed with a horizontal frame line 310 intersecting with a vertical frame line 320 as an example. However, by mutually intersecting, a plurality of frame lines forming predetermined angles therebetween can provide a variety of embodiments. In this case, a first frame line, a second frame line, etc. may be defined from the plurality of frame lines forming predetermined angles. In this embodiment, the horizontal frame line 310 will be designated as the first frame line, and the vertical frame line 320 will be designated as the second frame line.

The rack protecting body 200 is installed at the intersecting point between the horizontal and vertical frame lines 310 and 320, to fix the rack protecting body 200 at a predetermined point so that does not deviate in position. When the rack protecting body 200 collides with the door liner forming the inner surface of the door 111, it should not only absorb the shock, but also prevent scratches to the door liner. Accordingly, the rack protecting body 200 may be made of a rubber material that is soft and able to absorb shock.

To describe the above rack protecting bay 200 in more detail, the rack protecting body 200, as shown in FIG. 3, is formed vertically and includes a vertical cushion 210 formed vertically to couple to the vertical frame line 320 of the dish rack 300 and a horizontal cushion 220 formed horizontally to couple to the horizontal frame line 310 of the dish rack 300. The horizontal and vertical cushions 220 and 210 intersect to form a cross. In order to minimize the area of contact when the rack collides with the door liner, the portion of the vertical and horizontal cushions 210 and 220 contacting the door liner may be formed as a curved surface. The vertical and horizontal cushions 210 and 220 may be cylindrical.

An insert slot is cut in a predetermined width at the back of the rack protecting body 200 to insert the rack frame into.

In detail, a horizontal frame line insert slot 222 is cut horizontally into the rear of the horizontal cushion 220, and a vertical frame line insert slot 212 is cut vertically into the rear of the vertical cushion 210. Here, in the case of the vertical cushion 210, the vertical frame line insert slot 212 is formed at the back of the vertical cushion 210 in only the upper portion thereof (with respect to its intersection with the horizontal cushion 220), and only a hole 213 is formed without a slot in the lower portion thereof. The reason for this is to prevent the rack protecting body 200 from being easily pulled off of the dish rack 300 when slots are formed along the entire rear portion of the rack protecting body 200 in both horizontal and vertical directions and the rack protecting body 200 is installed on the dish rack 300, and a user or child should grasp the rack protecting body 200 and pull. Also, the widths of the frame line insert slots 212 and 222 may be formed to be smaller than the diameter of the rack frame, so that after the rack frame is inserted and mounted in frame line receiving grooves 211 and 221, the rack frame is not easily disconnected therefrom. The sizes of the frame line insert slots 212 and 222 may be formed to be a predetermined size smaller than the size of the frame line receiving grooves 211 and 221, to prevent disconnection of the rack protecting body 200.

In further detail, the frame line receiving grooves 211 and 221 having inner diameters equal to the outer diameter of the rack frame are formed in the central portion of the vertical and horizontal cushions 210 and 220. Accordingly, the horizontal frame line 310 is snap-fitted in the horizontal frame line receiving groove 221 through the horizontal frame line insert slot 222, and the vertical frame line 320 is snap-fitted in the vertical frame line receiving groove 211 through the vertical frame line insert slot 212. The frame line insert slots 212 and 222 and the frame line receiving groove 211 form a coupling portion for coupling the dish rack 300 with the rack protecting body 200.

In the process of coupling the rack protecting body 200 to the dish rack 300, an end of a frame line 320 is first inserted into the hole 213 for preventing disconnection. Then, when the rack protecting body 200 is pressed, the frame lines 310 and 320 insert through the insert slots 212 and 222 to snap-fit the frame lines 310 and 320 into the receiving grooves 211 and 221.

Through the above process, the rack protecting body 200 is snap-fitted to the dish rack 300, to prevent damage to the dish rack 300 and the door liner. The above advantage according to the present invention is much more pronounced when the door 111 is closed without completely inserting the dish rack 300 into the tub 110.

FIG. 4 is a plan view of the rack protecting body according to the first embodiment of the present invention.

Referring to FIG. 4, the radial center of the vertical cushion 210 and that of the receiving groove 211 formed in the vertical cushion 210 are offset by a predetermined distance (d1). The frame line 320 is inserted into this receiving groove 211. The radial center of the receiving groove 211 is thus eccentrically located, so that the thickness of the cushion 210 between the frame line 320 inserted into the receiving groove 211 and the door 111 is thicker than it would be if the radial center were centrally located. Therefore, when a collision with the door 111 occurs, the cushion 210 can more smoothly absorb the shock from the collision, to reliably protect the frame line 320 and the door 111.

Here, with respect to the frame line 320, the thickness of the cushion 210 towards the rear of the dish rack 300 is less than it is towards the front. In this way, when a collision with the door 111 occurs, the portion that can absorb the impact of the collision is thicker, so that the shock can be smoothly absorbed.

### MODE FOR THE INVENTION

Other embodiments according to the present invention will now be described with reference to the diagrams. In the descriptions, portions already described in the above first embodiment will be omitted and deemed replaced by the foresaid descriptions.

FIG. 5 is a perspective view of a rack protecting body according to the second embodiment of the present invention.

Referring to FIG. 5, the rack protecting body 200 according to this embodiment includes a cylindrical cushion 230 of a predetermined length and a sub frame line receiving groove 233 formed to intersect at the central portion of the cushion 230. Formed in the central portion of the cushion 230 is a main frame line receiving groove 231 for receiving the frame line of the dish rack 300. At the rear of the cushion 230 is a frame line insert slot 232 cut with a predetermined width. Here, the frame line receiving groove 233 and the frame line insert slot 232 may be formed to have widths that are smaller than the diameter of the frame line. In other words, the elasticity of the cushion 230 allows the rack protecting member 200 to firmly receive the rack frame.

The cushion 230 of the rack protecting body 200 of the above structure has the advantage of being able to selectively be snapped onto either the vertical or the horizontal frame line of the dish rack. Specifically, if the vertical frame line inserts into the main frame line receiving groove 231, the horizontal frame line inserts into the sub frame line receiving groove 233. Conversely, if the horizontal frame line inserts into the main frame line receiving groove 231, then the vertical frame line inserts into the sub frame line receiving groove 233. Accordingly, the rack protecting body 200 of this embodiment can be easily fixed to the rack frame to provide protection to the rack frame.

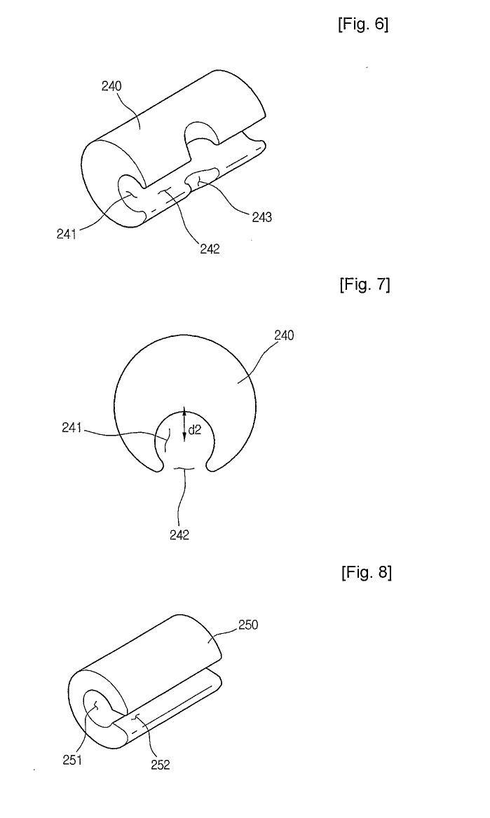

FIG. 6 is a perspective view of a rack protecting body according to the third embodiment of the present invention, FIG. 7 is a plan view of the rack protecting body according to the third embodiment of the present invention.

Referring to FIGS. 6 and 7, the cushion 240 forms a main frame line receiving groove 241, a sub frame line receiving groove 243, and a frame line insert slot 242.

The radial centers of the cushion 240 and the main frame line receiving groove 241 are separated by a distance (d2). The frame line 320 inserts into the main frame line receiving groove 241. Due to the offset of the radial center of the main frame line receiving groove 241 from the radial center of the cushion 240, the thickness of the cushion 240 between the frame line 320 inserted into the main frame line receiving groove 241 and the door 111 is thicker than it would be if there were no offset. Thus, when a collision with the door 111 occurs, the cushion 240 can more smoothly absorb the shock from the collision, and more reliably protect the frame line 320 and the door 111.

FIG. 8 is a perspective view of a rack protecting boy according to the fourth embodiment of the present invention.

Referring to FIG. 8, the rack protecting bow 200 includes a cushion 250, which is formed in a cylindrical shape of a predetermined length. The cushion 250 includes a frame line receiving groove 251 formed through its length. A frame line insert slot 252 is formed to connect the outer surface of the cushion 250 with the frame line receiving groove 251.

In this embodiment, the cushion 250 is formed as described above for easy assembly of the rack protecting body 200. The frame line 320 inserts through the frame line insert slot 252 into the frame line receiving groove 251, to install the rack protecting body 200. Therefore, the installation of the rack protecting body 200 can become easier.

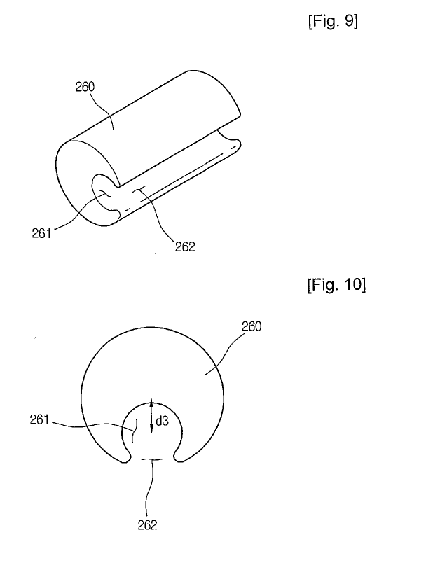

FIG. 9 is a perspective view of a rack protecting body according to the fifth embodiment of the present invention, and FIG. 10 is plan view of the rack protecting body according to the fifth embodiment of the present invention.

Referring to FIGS. 9 and 10, the cushion 260 forms a frame line receiving groove 261 and a frame line insert slot 262.

The radial centers of the cushion 260 and the receiving groove 261 are offset by a predetermined distance (d3). The frame line 320 inserts into the receiving groove 261. Due to the offset of the radial center of the receiving groove 261 from the radial center of the cushion 260, the thickness of the cushion 260 between the frame line 320 inserted into the receiving groove 261 and the door 111 is thicker than it would be if there were no offset. Thus, when a collision with the door 111 occurs, the cushion 260 can more smoothly absorb the shock from the collision, and more reliably protect the frame line 320 and the door 111.

### INDUSTRIAL APPLICABILITY

The rack protecting body of a dishwasher according to the present invention and the dishwasher using the same protect the dish rack and door from collisions between the door and the dish rack to prevent deformation and/or damage thereto, for a high industrial applicability.

1. A rack protecting body of a dishwasher having a dish rack, comprising:
a cushion for absorbing shock applied to the dish rack; and
a coupling portion for coupling the cushion with the dish rack.

2. The rack protecting body according to claim 1, wherein the coupling portion includes an insert slot for inserting a frame line of the dish rack through and a receiving groove for receiving the frame line inserted through the insert slot.

3. The rack protecting body according to claim 2, wherein the insert slot has a width that is smaller by a predetermined amount than a width of the receiving groove.

4. The rack protecting body according to claim 1, wherein the cushion is made of a rubber material.

5. The rack protecting body according to claim 1, wherein the cushion includes a portion subjected to shock having a curved surface.

6. The rack protecting body according to claim 1, wherein the coupling portion includes a radial center that is offset from a radial center of the cushion by a predetermined distance.

7. A rack protecting body of a dishwasher having dish rack formed of a rack frame with a plurality of intersecting frame lines, the rack protecting body comprising:
a cushion for absorbing shock applied to the dish rack; and
a frame line receiving groove for receiving the frame line, wherein the frame line receiving groove includes a radial center that is offset from a radial center of the cushion by a predetermined distance.

8. The rack protecting body according to claim 7, further comprising a frame line insert slot formed in the cushion for providing an inserting passage for the frame line.

9. The rack protecting body according to claim 8, wherein the frame line insert slot is cut into the cushion.

10. The rack protecting body according to claim 7, wherein the cushion includes a thickness at a side facing a forward direction of the dish rack with respect to the frame line that is thicker by a predetermined amount than a thickness at an opposite side thereof.

11. The rack protecting body according to claim 7, wherein the frame line receiving groove is formed in plurality for receiving the plurality of frame lines.

12. The rack protecting body according to claim 11, wherein the frame line receiving grooves formed in plurality are spaced a predetermined distance from one another.

13. The rack protecting body according to claim 7, wherein the frame line receiving groove is formed in one direction in the cushion.

14. The rack protecting body according to claim 7, wherein the cushion is formed in a cylindrical shape.

15. The rack protecting body according to claim 7, wherein the cushion includes a hole formed therein for enclosing a portion of the frame line inserted into the cushion.

16. The rack protecting body according to claim 7, wherein the frame line insert slot includes a width that is smaller by a predetermined amount than a diameter of the frame line that inserts therein.

17. A dishwasher comprising:
a door;
a tub opened and closed by the door;
a dish rack disposed within the tub; and
a rack protecting body for absorbing shock incurred by a collision between the door and the dish rack.

18. The dishwasher according to claim 17, wherein the rack protecting body is disposed on the dish rack opposite to the door.

19. The dishwasher according to claim 17, wherein the rack protecting body includes a portion opposite the door that is formed as a curved surface.

20. The dishwasher according to claim 17, wherein the rack protecting body encloses at least a portion of the dish rack.
